(19) United States
(12) Patent Application Publication
(10) Pub. No.: US 2012/0182405 A1
(43) Pub. Date: Jul. 19, 2012

(54) IMAGE DISPLAY METHOD AND IMAGE DISPLAY SYSTEM FOR ADJUSTING DISPLAY CONTROL SIGNAL TRANSMITTED TO DISPLAY SCREEN DURING EXTRA DRIVING PERIOD

(76) Inventors: Wei-Heng Huang, New Taipei City (TW); Chao-Shih Huang, New Taipei City (TW); Chueh-Pin Ko, New Taipei City (TW)

(21) Appl. No.: 13/164,767

(22) Filed: Jun. 20, 2011

(30) Foreign Application Priority Data
Jan. 14, 2011 (TW) 100101348

(51) Int. Cl. H04N 13/04; H04N 5/66

(52) U.S. Cl. 348/54; 348/739; 348/E05.133; 348/E13.026

(57) ABSTRACT

An image display method includes the following steps: transmitting an active data of a full image to a display screen, and after transmitting the active data of the full image is completed and before a driving period for an original vertical blanking interval corresponding to the active data is started, adjusting a display control signal transmitted to the display screen during an extra driving period, wherein a period length of the extra driving period is not equal to a period length of transmitting the active data of the full image to the display screen.

### BACKGROUND OF THE INVENTION

1. Field of the Invention

The present invention relates to an image display technology, and more particularly, to an image display method and image display system for adding an extra driving period and adjusting a display control signal transmitted to a display screen during the extra driving period for allowing the transmission of an active data of a full image to be finished in advance.

2. Description of the Prior Art

With the development of science and technology, users are pursing stereoscopic and more real image displays rather than high quality images. There are two techniques of present stereo image display. One is to use a video output apparatus which collaborates with a pair of glasses (e.g. a pair of anaglyph glasses, a pair of polarization glasses or a pair of shutter glasses), while the other directly uses a video output apparatus without any accompanying pair of glasses.

For a pair of shutter glasses, it is widely used for users to view stereo images presented by a video output apparatus. The pair of shutter glasses includes two shutter lenses, and allows user's left eye to see left-eye images and right eye to see right-eye images by properly switching the shutter lenses between an on-state and an off-state.

As mentioned above, the main principle of three-dimensional image displaying is to allow the left eye and the right eye to see different images. Therefore, when a video output apparatus which collaborates with a pair of glasses (e.g., a pair of shutter glasses) is presenting stereo images to the user, it has to properly control the shutter lenses to switch between an on-state and an off-state for allowing the user's left eye and right eye to see different images. How to present stereo images to the user by properly controlling the shutter lenses to switch between an on-state and an off-state according to an image output of the video display apparatus becomes an important issue in this technical field.

Besides, regarding a liquid crystal display (LCD) screen, since the rotation of the liquid crystal cell requires a period to be stable, how to update the displayed image in advance to avoid crosstalk also becomes an important issue in this technical field.

### SUMMARY OF THE INVENTION

Therefore, one of the objectives of the present invention is to provide an image display method and image display system for adding an extra driving period and adjusting a display control signal transmitted to a display screen during the extra driving period for allowing transmission of an active data of a full image to be finished in advance to solve the aforementioned problem.

According to a first aspect of the present invention, an image display method is disclosed. The image display method includes: transmitting an active data of a full image to a display screen; after transmitting the active data to the display screen being finished and before a driving period of an original vertical blanking interval (VBI) corresponding to the active data being started, adjusting a display control signal transmitted to the display screen during an extra driving period, wherein a period length of the extra driving period is not equal to a period length of transmitting the active data of a full image to the display screen.

According to a second aspect of the present invention, further discloses an image display system. The image display system includes a video display apparatus and a display control circuit. The display control circuit is coupled to the display screen, for transmitting an active data of a full image to the display screen to the display screen, and after transmitting the active data to the display screen being completed and before a driving period of an original vertical blanking interval (VBI) corresponding to the active data being started, adjusts a display control signal transmitted to the display screen during an extra driving period, wherein a period length of the extra driving period is not equal to a period length of transmitting the active data of a full image to the display screen.

According to a third aspect of the present invention, further discloses an image display method. The image display method includes: transmitting an active data of a full image to a display screen; and after transmitting the active data to the display screen being started and before transmitting the active data to the display screen being finished, adjusting a display control signal transmitted to the display screen during at least an extra driving period.

According to a fourth aspect of the present invention, further discloses an image display system. The image display system includes a video display apparatus. The video display apparatus includes a display screen and a display control circuit. The display control circuit is coupled to the display screen, for transmitting an active data of a full image to the display screen, and after transmitting the active data to the display screen being started and before transmitting the active data to the display screen being finished, adjusting a display control signal transmitted to the display screen during at least an extra driving period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram illustrating an image display system according to an exemplary embodiment of the present invention.

FIG. 2 is a diagram illustrating the three-dimensional image display operation performed by the image display system shown in FIG. 1.

FIG. 3 is a diagram illustrating the operation of the display control circuit driving the display screen.

FIG. 4 is a diagram illustrating the operation of adjusting a display control signal transmitted to a display screen during an extra driving period for allowing transmission of an active data of a full image to be finished in advance.

FIG. 5 is a flowchart illustrating the image display method according to an exemplary embodiment of the present invention.

FIG. 6 is a diagram illustrating another image display operation performed by the image display system shown in FIG. 1.

FIG. 7 is a flowchart illustrating the image display method outputting a display control signal to the display screen according to a first exemplary embodiment of the present invention.

FIG. 8 is a flowchart illustrating the image display method outputting a display control signal to the display screen according to a second exemplary embodiment of the present invention.

FIG. 9 is a timing diagram of an active data, a frame buffer and a display screen.

### DETAILED DESCRIPTION

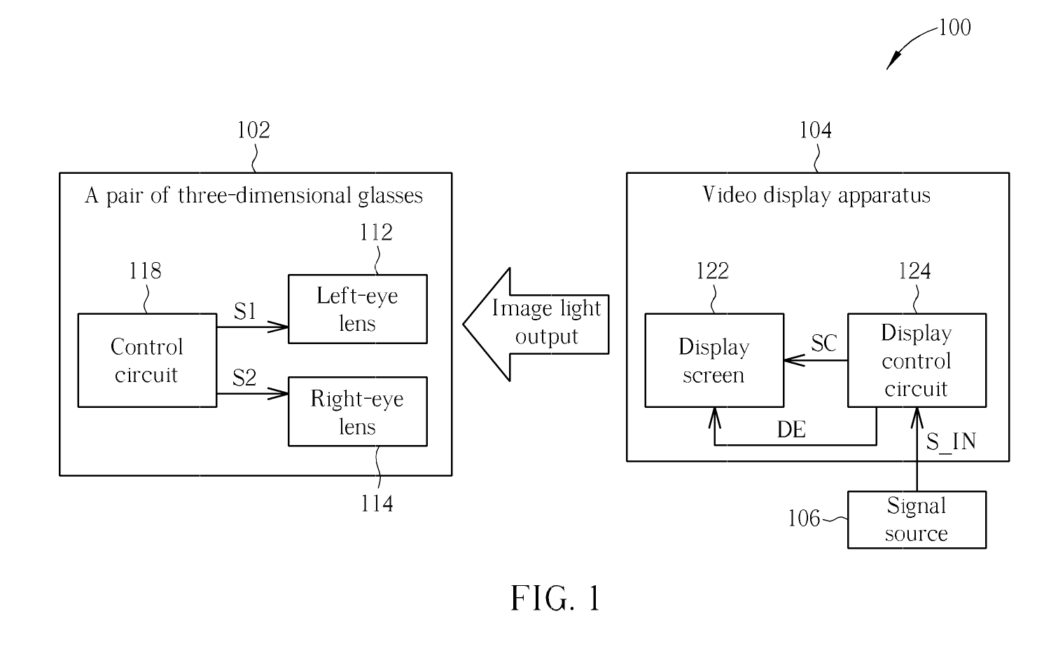

Please refer to FIG. 1, which is a function block diagram illustrating an image display system according to an exemplary embodiment of the present invention. The image display system 100 includes a pair of three-dimensional (3D) glasses 102 and a video display apparatus 104. In this exemplary embodiment, the video display apparatus 104 is capable of being operated in a 3D image display mode or a two-dimensional (2D) image display mode. When the video display apparatus 104 is operated in the 3D image display mode, the video display apparatus 104 may provide 3D images to the user by collaborating with the pair of 3D glasses 102. When the video display apparatus 104 is operated in the 2D image display mode, the user does not need to wear the pair of 3D glasses 102 and may see the 2D images presented by the video display apparatus 104 directly. As shown in the figure, the pair of 3D glasses 102 includes, but is not limited to, a left-eye lens 112, a right-eye lens 114 and a control circuit 118. The video display apparatus 104 includes, but is not limited to, a display screen 122 and a display control circuit 124. The left-eye lens 112 is utilized for allowing the user to view left-eye images, and the right-eye lens 114 is utilized for allowing the user to view right-eye images. Moreover, the control circuit 118 is electrically connected to the left-eye lens 112 and the right-eye lens 114, and utilized for controlling the left-eye lens 112 to switch between an on-state and an off-state and controlling the right-eye lens 114 to switch between an on-state and an off-state by respectively outputting control signals S1, S2 to the left-eye lens 112 and the right-eye lens 114. For example, suppose that the pair of 3D glasses 102 is a pair of shutter glasses. Therefore, the left-eye lens 112 and the right-eye lens 114 are both shutter lenses, and respectively have liquid crystal (LC) layers. Besides, the control signals S1, S2 may be control voltages utilized for controlling the rotation of the liquid crystal (LC) cells within the LC layers to achieve the objective of controlling light transmission rate. However, this is for illustrative purposes only, and is not meant to be a limitation of the present invention. For example, any structures capable of controlling light transmission rate may be utilized for realizing the left-eye lens 112 and the right eye lens 114, and the same objective of controlling the left-eye lens 112 and the right-eye lens 114 to switch between an on-state and an off-state may be achieved. Moreover, the pair of 3D glasses 102 is not limited to a pair of shutter glasses. Any pair of 3D glasses capable of collaborating within the video display apparatus 104 for allowing the user to view 3D images and employing the 3D image display mechanism disclosed in the present invention obeys the spirit of the present invention.

In the present invention, the “off-state” described above means that the left-eye lens/the right-eye lens is totally opaque (i.e., the light transmission rate is 0%). Therefore, as long as the left-eye lens/the right-eye lens is not totally opaque (i.e., the light transmission rate is not 0%), it may be regarded as staying in the “on-state”. For example, when the left-eye lens/the right-eye lens is fully open (e.g., the light transmission rate is 100%), half open (e.g., the light transmission rate is 50%), or slightly open (e.g., the light transmission rate is 0.1%), the shutter lens may be regarded as staying in an on-state. In brief, when the light transmission rate of the left-eye lens/the right-eye lens is larger than 0% (but smaller than or equal to 100%), the left-eye lens/the right-eye lens may be regarded as staying in an on-state.

A user may wear the pair of 3D glasses 102 to view stereo images presented by the video output apparatus 104 via the display screen 122. For example, in the exemplary embodiment shown in FIG. 1, the video output apparatus 104 may be a liquid crystal display (LCD) apparatus. Therefore, the display screen 122 is an LCD screen which includes an LCD panel, a backlight module and other related components. The pair of 3D glasses 102 controls whether image light output generated by the display screen 122 may reach user's left eye or right eye. Please note that the video output apparatus 104 is not limited to an LCD apparatus; that is, the video output apparatus 104 may by any video output apparatus that collaborates with the pair of 3D glasses 102 for presenting 3D images to the user. For example, the video output apparatus 104 may be an organic light-emitting diode (OLED) display, a plasma display, a digital light processing (DLP) display/projector, a liquid crystal on Silicon (LCoS) display/projector, etc. In other words, if the pair of 3D glasses 102 is a pair of shutter glasses, the video display apparatus 104 is any display or projector that collaborates with the pair of shutter glasses.

Regarding the exemplary embodiment utilizing a pair of shutter glasses as the pair of 3D glasses 102, the control circuit 118 may be utilized for properly controlling the left-eye lens 112 and the right-eye lens 114 to switch between an on-state and an off-state. For example, the video display apparatus 104 may communicate with the pair of 3D glasses 102 via a signal transmitter (not shown). For example, the pair of 3D glasses 102 (e.g., a pair of shutter glasses) may receive information transmitted from the video output apparatus 104 through wired or wireless transmission (e.g., infrared transmission, ZigBee transmission, ultrawideband (UWB) transmission, WiFi transmission, radio frequency (RF) transmission, DLP light signal transmission or Bluetooth transmission). The control circuit 118 may generate required control signals S1, S2 according to the received information. As those skilled in the art will readily know the communication mechanism between the pair of 3D glasses and the video display apparatus, related details are omitted here for brevity.

In this exemplary embodiment, for each full image display, the display control circuit 124 outputs a display control signal SC to drive the display screen 122. More specifically, in this exemplary embodiment, the display control circuit 124 transmits an active data of a full image to the display screen 122 via the display control signal SC, and after transmitting the active data to the display screen 122 is finished, the display control circuit 124 transmits a partial display data of the active data to the display screen 122. Besides, during the partial display data being transmitted to the display screen 122, the control circuit 118 further switches on a lens of the pair of 3D glasses 102 that is used for allowing the user to watch the full image. For example, if the full image is a left-eye image, the control 118 switches the left-eye lens 112 from an off-state to an on-state in order to allow the user's left eye to see the content presented by the display screen 122. On the other hand, if the full image is a right-eye image, the control 118 switches the right-eye lens 114 from an off-state to an on-state in order to allow the user's right eye to see the content presented by the display screen 122. The techniques directed to using the control circuit to switch the shutter lens between the on-state and the off-state have been described the same inventor's other U.S. patent applications, which claim the benefit of counterpart Taiwanese patent application No. 099122343, Taiwanese patent application No. 099124293, and Taiwanese patent application No. 099126274 respectively and are incorporated herein by reference. Further description is therefore omitted here for brevity.

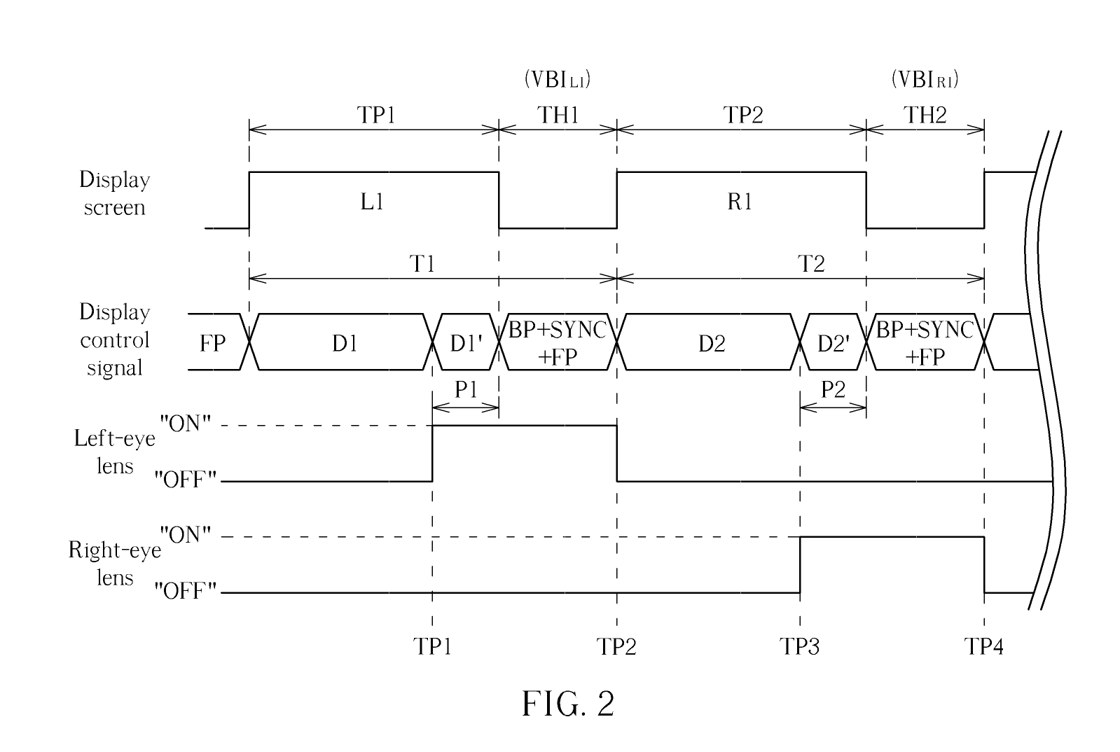

Please refer to FIG. 2, which is a diagram illustrating the 3D image display operation performed by the image display system shown in FIG. 1. In this exemplary embodiment, the video display apparatus 104 alternately displays a left-eye image L1 and a right-eye image R1 during a plurality of image output period (e.g., T1 and T2), respectively. Moreover, as shown in the figure, each image output period includes an image driving period and an image stabilization period (e.g., a vertical blanking interval, (VBI)), wherein the image output period T1 includes an image driving period TP1 and an image stabilization period TH1, and the image output period T2 includes an image driving period TP2 and an image stabilization period TH2. During the image driving period TP1/TP2, the display screen 122 receives active data, and displays corresponding image content in an active area according to the active data. Besides, during the image stabilization period TH1/TH2, the display screen 122 does not receive any active data. Thus, there is no image content displayed in the blanking area which is located outside of the active area.

Moreover, regarding display control of each image, besides the aforementioned active data, the display control signal SC output by the display control circuit 124 further includes a front porch signal FP, a back porch signal BP and a synchronization signal SYNC. As shown in FIG. 2, when the display control circuit 124 is to drive the display screen 122 to display the left-eye image L1, the display control circuit 124 sequentially outputs FP, D1, D1′, BP and SYNC, wherein the original vertical blanking interval VBI_{L1} corresponding to the active data of the left-eye image L1 may be regarded as BP+SYNC+FP, and when the display control circuit 124 is to drive the display screen 122 to display the right-eye image R1, the display control circuit 124 sequentially outputs FP, D2, D2′, BP and SYNC, wherein the original vertical blanking interval VBI_{L1} corresponding to the active data of the right-eye image R1 may be regarded as BP+SYNC+FP.

Please note that D1 is the active data corresponding to the full left-eye image L1 and utilized for driving all scan lines in the active area of the display screen 122, and D1′ is a partial display data of the active data corresponding to the full left-eye image L1 and utilized for driving part of the scan lines in the active area of the display screen 122. Similarly, D2 is the active data corresponding to the full right-eye image R1 and utilized for driving all scan lines in the active area of the display screen 122, and D2′ is a partial display data of the active data corresponding to the full right-eye image R1 and utilized for driving part of the scan lines in the active area of the display screen 122.

In other words, after transmitting the active data D1 to the display screen 122 is finished and before a driving period of an original vertical blanking interval VBI_{L1} corresponding to the active data D1 is started, the display control circuit 124 adjusts the display control signal SC transmitted to the display screen 122 during an extra driving period P1 to append a partial display data D1′ thereto, wherein a period length of the extra driving period P1 is not equal to a period length of transmitting the active data D1 of the full left-eye image L1 to the display screenl 22 (e.g., P1<TP1−P1). Similarly, after transmitting the active data D2 to the display screen 122 is finished and before a driving period of an original vertical blanking interval VBI_{R1} corresponding to the active data D2 is started, the display control circuit 124 adjusts the display control signal SC transmitted to the display screen 122 during an extra driving period P2 to append a partial display data D2′ thereto, wherein a period length of the extra driving period P2 is not equal to a period length of transmitting the active data D2 of the full right-eye image R1 to the display screenl 22 (e.g., P2<TP2−P2).

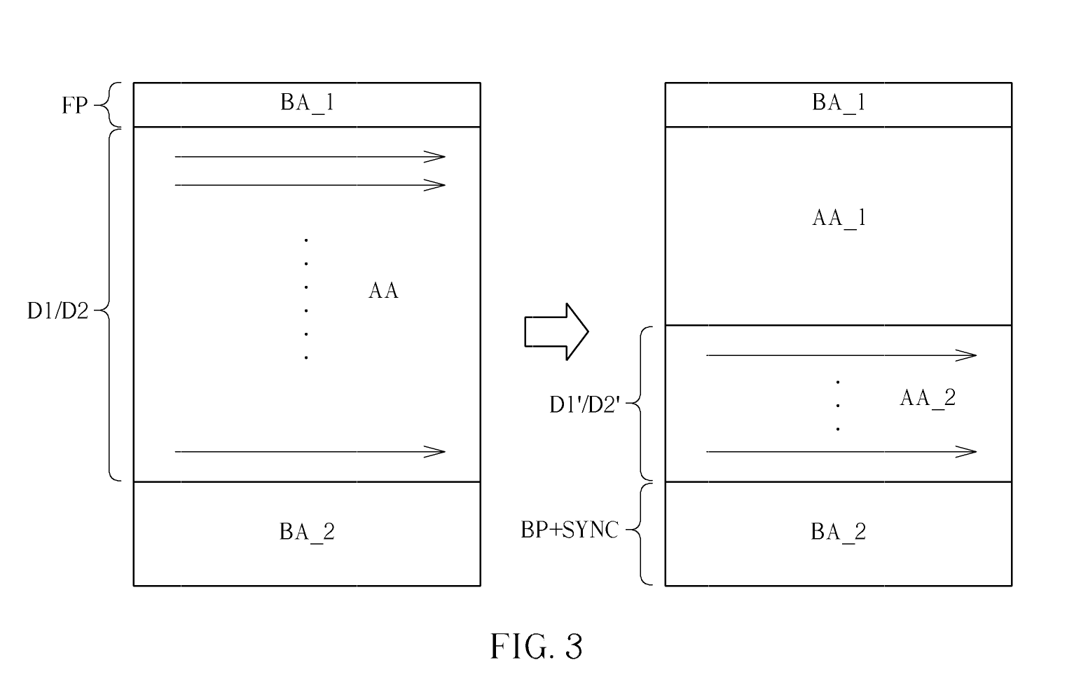

Please refer to FIG. 3, which is a diagram illustrating the operation of the display control circuit 124 driving the display screen 122. As shown in the figure, the output image of the display screen 122 may be divided into an active area AA that includes a first active area AA_1 and a second active area AA_2 and a blanking area that includes a first blanking area BA_1 and a second blanking area BA_2. When the display control signal SC output by the display control circuit 124 transmits the front porch FP, the front porch FP will not make any image output displayed in the first blanking area BA_1, and when the display control signal SC output by the display control circuit 124 transmits the following active data D1/D2, the display screen 122 refers to the active data D1/D2 to sequentially drive and update each scan line in the active area AA. For example, the display screen 122 sequentially updates pixels in each scan line from left to right and updates each scan line from top to bottom, as shown by the arrow symbol in FIG. 3. For example, if the resolution of the image to be displayed in the active area AA is 1920×1080, the display screen 122 drives and updates 1080 scan lines according to the active data D1/D2. As aforementioned, when the display control circuit 124 finishes transmitting the active data D1/D2 to the display screen 122, the display control circuit 124 will immediately transmit a partial display data D1′/D2′ of the active data D1/D2. That is, the partial display data D1′/D2′ includes the display data corresponding to a plurality of scan lines within the full image (i.e., the full image displayed in the active area AA). In one exemplary embodiment, the plurality of scan lines are successive scan lines. So, the complexity for controlling the display screen 122 to drive part of the scan lines again in the active area AA according to the partial display data D1′/D2′ may be reduced.

In another exemplary embodiment, the last one of the plurality of scan lines is the last one scan line of the full image (i.e., the full image displayed in the active area AA). For example, suppose that the display screen 122 is an LCD screen and its largest bandwidth is 100 Mhz. Under the condition where the resolution of the image to be displayed in the active area AA is 1920×1080, the partial display data D1′/D2′ may include the display data corresponding to at most 440 scan lines. Therefore, in one exemplary implementation, the partial display data D1′/D2′ transmitted by the display control signal SC which is output by the display control circuit 124 corresponds to the display data of the 641^{st}-1080^{th} scan lines. Therefore, the display screen 122 will update the 641^{st} scan lines to the 1080^{th} scan lines again according to the same display data, as shown in FIG. 3. So, since the display screen 122 is an LCD screen and sequentially drives the first scan lines to the 1080^{th} scan lines according to the active data D1/D2, when the pixels (i.e., LC cells) located at the earlier driven scan lines finish rotating, the pixels (i.e., LC cells) located at the latter driven scan lines does not finish rotating yet. Therefore, driving these latter driven scan lines again, such as applying over-drive voltages to pixels located at these latter driven scan lines, may achieve the effect of accelerating the rotation process of the pixels (i.e., LC cells).

According to other exemplary embodiments, the display control circuit 124 may generate the aforementioned partial display data D1′/D2′ according to display data corresponding to 440 scan lines randomly selected from the 1080 scan lines. Besides, the number of scan lines corresponding to the partial display data D1′/D2′ is not limited to 440. In fact, the number of scan lines may be set according to the bandwidth limitation of the display screen 122 and the actual application requirement.

Next, when the display control signal SC output by the display control circuit 124 finishes transmitting the partial display data D1′/D2′, the display control circuit 124 sequentially transmits the back porch signal BP and the synchronization signal SYNC via the display control signal SC. The back porch signal BP and the synchronization signal SYNC will not make the second blanking area BA_2 have any image output displayed therein.

Regarding the pair of 3D glasses 102 in FIG. 2, during the partial display data D1′/D2′ being transmitted to the display screen 122, the control circuit 118 switches on a lens included in the pair of 3D glasses 102 for allowing the user to watch corresponding images. In this exemplary embodiment, at the time point TP1, the display control signal SC output by the display control circuit 124 starts transmitting partial display data D1′. Therefore, the control signal S1 switches the left-eye lens 112 from the off-state “OFF” to the on-state “ON” at the time point TP1, and the left-eye lens 112 is not switched from the on-state “ON” to the off-state “OFF” until the display control signal SC output by the display control circuit 124 starts transmitting the following active data D2 of the right-eye image R1 at the time point TP2. Similarly, at the time point TP3, the display control signal SC output by the display control circuit 124 starts transmitting the partial display data D2′. Therefore, the control signal S2 switches the right-eye lens 114 from the off-state “OFF” to the on-state “ON” at the time point TP3, and the right-eye lens 114 is not switched from the on-state “ON” to the off-state “OFF” until the display control signal SC output by the display control circuit 124 starts transmitting the active data of the following image at the time point TP4.

In brief, the partial display data D1′/D2′ may be regarded as extended active data of the original active data D1/D2. Suppose that the time required for transmitting the original active data D1/D2 is 8.2 ms. When the partial display data D1′/D2′ is appended to the original active data D1/D2 according to the present invention, the transmission of the active data D1/D2 is accelerated (e.g., the transmission may be finished in 5.6 ms) to thereby let the display screen 122 (e.g., an LCD screen) have enough time to finish stabilization of the full image; besides, the time period (about 2.6 ms) of transmitting the extended active data (i.e., the partial display data D1′/D2′) may be utilized for allowing the user to watch the 3D images.

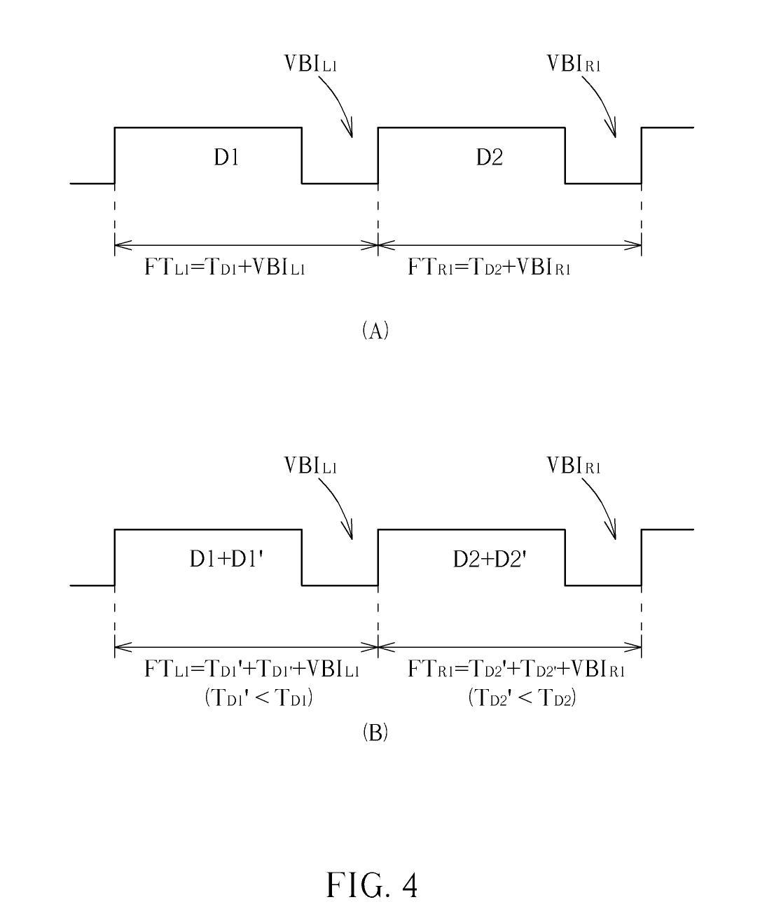

In the sub-diagram (A) of FIG. 4, since the driving mechanism of the present invention is not employed to provide any extra driving period, the driving period for a full image may be expressed as below:

FT_{L1}=T_{D1}+vBI_{L1} (1)

FT_{R1}=T_{D2}+VBI_{R1} (2)

In the aforementioned equations (1) and (2), FT_{L1} represents the required time for the display control circuit 124 to drive the left-eye image L1, and T_{D1} represents the required time for the display control circuit 124 to transmit the active data D1 of the full left-eye image L1 to the display screen 122. Moreover, FT_{R1} represents the required time for the display control circuit 124 to drive the right-eye image R1, and T_{D2} represents the required time for the display control circuit 124 to transmit the active data D2 of the full right-eye image R1 to the display screen 122.

In the sub-diagram (B) of FIG. 4, since the driving mechanism of the present invention is employed to provide an extra driving period (e.g., the aforementioned P1 and P2), the driving period for finishing a full image may be presented as below:

FT_{R1}=T_{D2}′+T_{D1′}+VBI_{L1} (3)

FT_{R1}=T_{D2}′+T_{D2′}+VBI_{R1} (4)

In the aforementioned equations (3) and (4), T_{D1′} represents the required time for the display control circuit 124 to transmit the partial active data D1′ to the display screen 122 (i.e., the aforementioned extra driving period P1). Moreover, T_{D2′} represents the required time for the display control circuit 124 to transmit the partial active data D2′ to the display screen 122 (i.e., the aforementioned extra driving period P2).

As can be known from FIG. 4, under the condition where the driving period FT_{L1} of the same full image is not changed, when the display control circuit 124 needs to additionally transmit the partial display data D1′, the display control circuit 124 will utilize a larger transmission bandwidth to transmit the active data D1 and the partial display data D1′. Therefore, T_{D1}′ would be shorter than T_{D1}. Compared with the conventional driving mechanism, the driving mechanism of the present invention will allow the transmission of the active data D1 to be finished in advance, thereby allowing the display screen 122 (e.g., an LCD screen) to have sufficient time to stabilize the display output of the left-eye image L1. Similarly, under the condition where the driving period FT_{R1} of the same full image is not changed, when the display control circuit 124 needs to additionally transmit the partial display data D2′, the display control circuit 124 will utilize a larger transmission bandwidth to transmit the active data D2 and the partial display data D2′. Therefore, T_{D2}′ would be shorter than T_{D2}. In this way, the transmission of the active data D2 is finished in advance, thereby allowing the display screen 122 (e.g., an LCD screen) to have sufficient time to stabilize the display output of the right-eye image R1.

Please note that the aforementioned partial display data D1′/D2′ may be generated by the display control circuit 124. In other words, the display control circuit 124 may receive active data D1/D2 transmitted by an input signal S_IN from a signal source 106 (e.g., a host computer or a multimedia player). Next, the display control circuit 124 generates the partial display data D1′/D2′ according to the received active data D1/D2. Moreover, the display control circuit 124 sequentially transmits the received active data D1/D2 and the generated partial display data D1′/D2′ to the display screen 122. For example, the structure of the display control circuit 124 includes at least a scalar which generated the partial display data D1′/D2′ via the internal micro-processor and temporarily stores the received active data D1/D2 and the generated partial display data D1′/D2′ into a frame buffer. Next, the active data D1/D2 and the partial display data D1′/D2′ temporarily stored in the frame buffer are sequentially transmitted to the display screen 122 via the process of the following circuit components.

In another exemplary embodiment, the structure of the display control circuit 124 includes at least a timing controller (T-con) and a scalar. The scalar generates the aforementioned active data D1/D2 by performing a scaling process according to the original active data provided by the signal source 106, and then transmits the active data D1/D2 to the timing controller. The timing controller generates the required partial display data D1′/D2′ according to the active data D1/D2, and sequentially transmits the received active data D1/D2 and the generated partial display data D1′/D2′ for driving the display screen 122.

Please note that the display screen 122 and the display control circuit 124 shown in FIG. 1 are represented by different function blocks. However, this by no means implies that the display screen 122 and the display control circuit 124 have to be disposed respectively. In fact, part of the circuits (e.g., the timing controller) or all of the circuits of the display control circuit 124 may be integrated to the display screen 122 according to the practice design, and these alternative designs all fall within the scope of the present invention.

Moreover, the aforementioned partial display data D1′/D2′ may also be generated by the signal source 106 (e.g., a host computer or a multimedia player). The display control circuit 124 merely receives the active data D1/D2 and the partial display data S1′/D2′ transmitted by the input signal S_IN, and sequentially transmits the received active data D1/D2 and the partial display data D1′/D2′ to the display screen 122 to initiate the following display screen driving procedure.

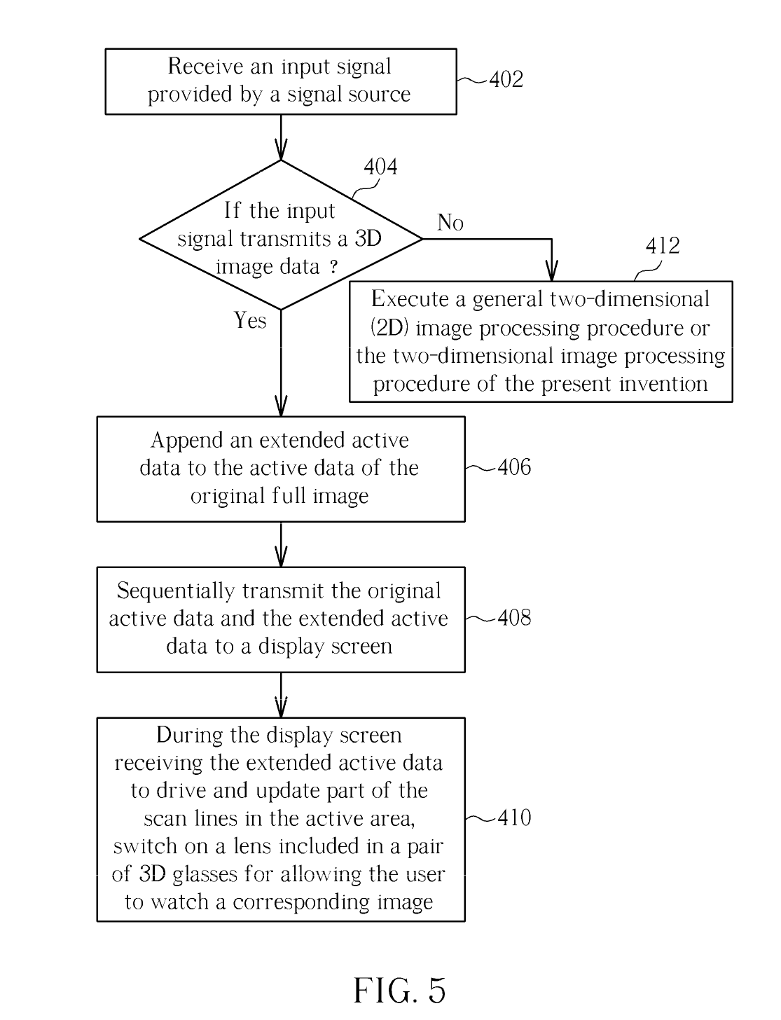

FIG. 5 is a flowchart illustrating the image display method according to an exemplary embodiment of the present invention, which may be employed in the image display system 100 shown in FIG. 1. The method may be concluded as below:

Step 402: Receive an input signal provided by a signal source;

Step 404: Determine if the input signal transmits a 3D image data? If yes, go to step 412; otherwise, go to step 406;

Step 406: Append an extended active data (e.g., the aforementioned D1′/D2′) to the active data of the original full image (e.g., the aforementioned D1/D2);

Step 408: Sequentially transmit the original active data and the extended active data to a display screen (e.g., an LCD screen);

Step 410: During the display screen receiving the extended active data to drive and update part of the scan lines in the active area, switch on a lens (i.e., a left-eye lens or a right-eye lens) included in a pair of 3D glasses for allowing the user to watch a corresponding image;

Step 412: Execute a general two-dimensional (2D) image processing procedure or the two-dimensional image processing procedure of the present invention.

The step 404 checks the content of the input signal to determine whether the 3D image processing procedure of the present invention (i.e., step 406 to step 410), the general 2D image processing procedure, or the 2D image processing procedure of the present invention (i.e., applying a technique that uses at least an extra driving period and adjusts the display control signal of the display screen during the extra driving period for allowing the transmission of the active data of the full image to be finished in advance to the 2D image display) is employed (step 412). For example, the step 404 may be executed by the scalar in the display control circuit 124. However, this is for illustrative purposes only, and is not meant to be a limitation of the present invention. Moreover, as those skilled in the art will readily understand the operation of other steps after reading above paragraphs directed to the image display system 100 shown in FIG. 1, further description is omitted here for brevity.

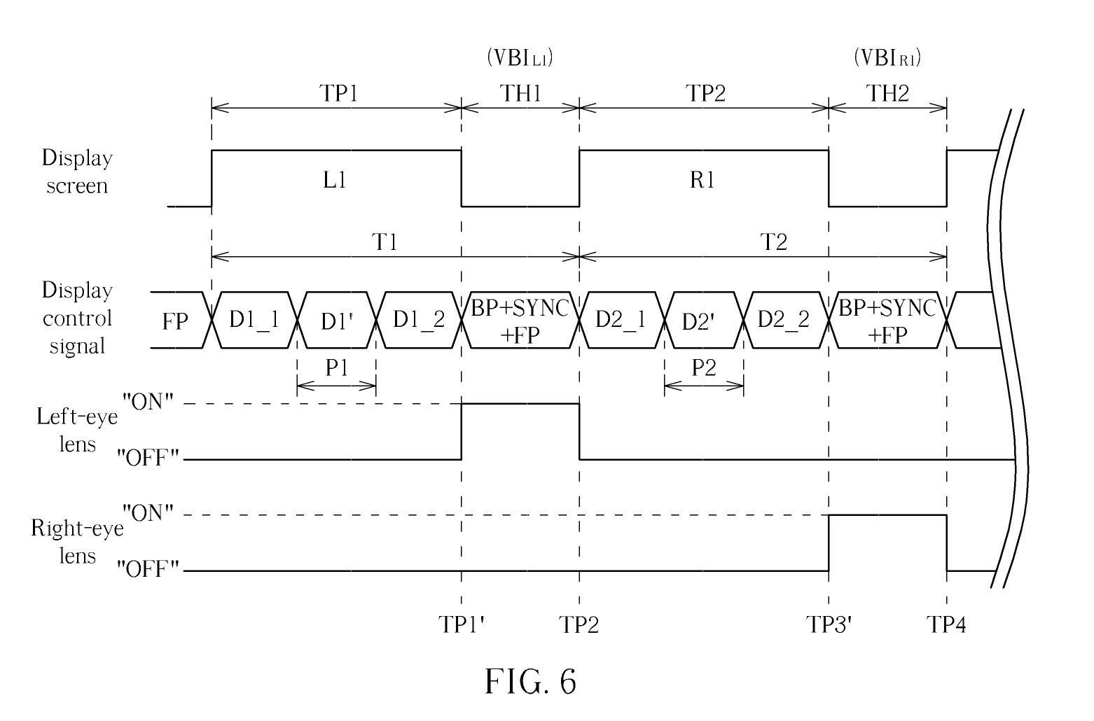

In the aforementioned exemplary embodiments, each extra driving period (e.g., P1 and P2 shown in FIG. 2) is started after transmitting the active data (e.g. D1/D2) to the display screen 122 is finished and is ended before a driving period of an original vertical blanking interval (e.g., VBI_{L1}/VBI_{R1}) corresponding to the active data is started. However, this is for illustrative purposes only, and is not meant to be a limitation of the present invention. In another exemplary embodiment, the extra driving period may be started after transmitting the active data to the display screen 122 is started and may be ended before transmitting the active data to the display screen 122 is finished. FIG. 6 is a diagram illustrating another image display operation performed by the image display system shown in FIG. 1. As shown in the figure, the display control circuit 124 first transmits one partial data D1_1 of the active data D1 corresponding to the full left-eye image L1, and then transmits the aforementioned partial display data D1′ during the extra driving period P1 (P1<TP1−P1). Next, the display control circuit 124 continuously transmits the other partial data D1_2 of the active data D1. Please note that, in this exemplary embodiment, D1=D1_1+D1_2. However, if more than one extra driving period is inserted, the original active data D1 will be divided into more parts to be transmitted. Similarly, the display control circuit 124 first transmits one partial data D2_1 of the active data D2 corresponding to the full right-eye image R1, and then transmits the aforementioned partial display data D2′ during the extra driving period P2 (P2<TP2−P2). Next, the display control circuit 124 continuously transmits the other partial data D2_2 of the active data. Please note that, in this exemplary embodiment, D2=D2_1+D2_2. However, if more than one extra driving period is inserted, the original active data D2 will be divided into more parts to be transmitted.

For example, suppose that the resolution of the image is 1920×1080. In one exemplary implementation, the partial data D1_1/D2_1 is the display data of the 1^{st} scan line, and the other partial data D1_2/D2_2 is the display data of the 2^{nd}-1080^{th} scan lines. In another exemplary implementation, the partial data D1_1/D2_1 is the display data of the 1^{st}-1079^{th} scan lines, and the other partial data D1_2/D2_2 is the display data of the 1080^{th} scan line. In other words, each extra driving period may be inserted into any position during the period of transmitting the active data of the full image according to actual design consideration. Moreover, the number of inserted extra driving periods may be adjusted according to actual design consideration. Besides, since the detail of generating and transmitting the partial display data D1′/D2′ has been described in the paragraphs directed to the exemplary embodiment shown in FIG. 2, further description is omitted here for brevity.

Regarding the pair of 3D glasses 102, it will switch on a lens for allowing the user to watch the full image after the display control circuit 124 finishes transmitting the active data to the display screen 122. In this exemplary embodiment, at the time point TP1′ shown in FIG. 6, the display control circuit 124 finishes transmitting the original active data D1 corresponding to the left-eye image L1 to the display screen 122. Therefore, the control signal S1 controls the left-eye lens 112 to switch from the off-state “OFF” to the on-state “ON” at the time point TP1′, and the left-eye lens 112 is not switched from the on-state “ON” to the off-state “OFF” until the display control signal SC output by the display control circuit 124 starts transmitting the following active data D2 of the right-eye image R1 at the time point TP2. Similarly, at the time point TP3′, the display control circuit 124 finishes transmitting the original active data D2 corresponding to the right-eye image R1 to the display screen 122. Therefore, the control signal S2 switches the right-eye lens 114 from the off-state “OFF” to the on-state “ON” at the time point TP3′, and the right-eye lens 114 is not switched from the on-state “ON” to the off-state “OFF” until the display control signal SC output by the display control circuit 124 starts transmitting the active data of the following image at the time point TP4.

The newly added extra partial display data D1′/D2′ may accelerate the transmission of the active data D1/D2 (e.g., the transmission may be finished in 5.6 ms), thereby allowing the display screen 122 (e.g., an LCD screen) to have sufficient time to stabilize the display of the full image. In this way, the display quality of the 3D image is improved.

In the exemplary embodiments shown in FIG. 2 and FIG. 6, the operation that the display control circuit 124 adjusts the display control signal SC transmitted to the display screen 122 during the extra driving period P1/P2 is transmitting the partial display data D1′/D2′ of the active data D1/D2 to the display screen 122, where the partial display data D1′/D2′ may be composed of one or a plurality of scan lines in the active data D1/D2. However, other implementations are also feasible. For example, in another exemplary embodiment, the operation that the display control circuit 124 adjusts the display control signal SC transmitted to the display screen 122 during the extra driving period P1/P2 is transmitting display data corresponding to a black image content (e.g., the display data whose pixel values are all “0”) to the display screen 122. In another exemplary embodiment, the operation that the display control circuit 124 adjusts the display control signal SC transmitted to the display screen 122 during the extra driving period P1/P2 is transmitting display data corresponding to a white image content (e.g., the display data whose pixel values are all “255”) to the display screen 122. In yet another exemplary embodiment, the operation that the display control circuit 124 adjusts the display control signal SC transmitted to the display screen 122 during the extra driving period P1/P2 is not transmitting any signal to the display screen 122.

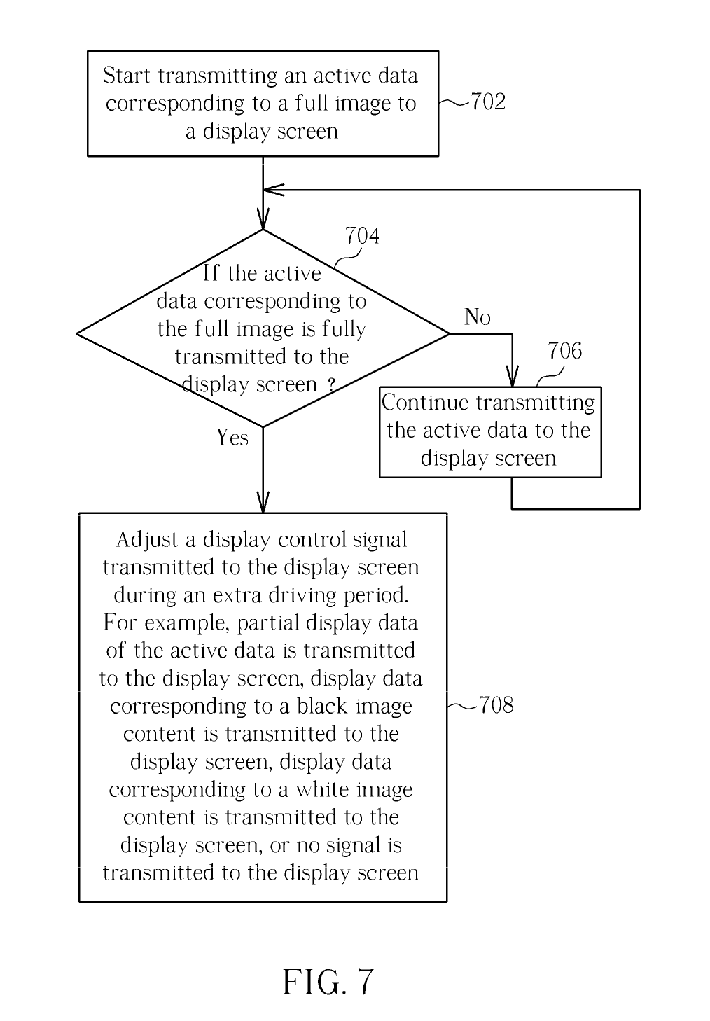

FIG. 7 is a flowchart illustrating the image display method outputting a display control signal to the display screen according to a first exemplary embodiment of the present invention. The flowchart may be concluded as below:

Step 702: Start transmitting an active data (e.g., D1/D2) corresponding to a full image (e.g., L1/R1) to a display screen;

Step 704: Determine if the active data corresponding to the full image is fully transmitted to the display screen. If yes, go to step 708; otherwise, go to step 706;

Step 706: Continue transmitting the active data to the display screen, and execute step 704;

Step 708: Adjust a display control signal transmitted to the display screen during an extra driving period (e.g., P1/P2). For example, partial display data of the active data is transmitted to the display screen, display data corresponding to a black image content is transmitted to the display screen, display data corresponding to a white image content is transmitted to the display screen, or no signal is transmitted to the display screen. Besides, a period length of the extra driving period is not equal to a period length of transmitting the active data of the full image to the display screen.

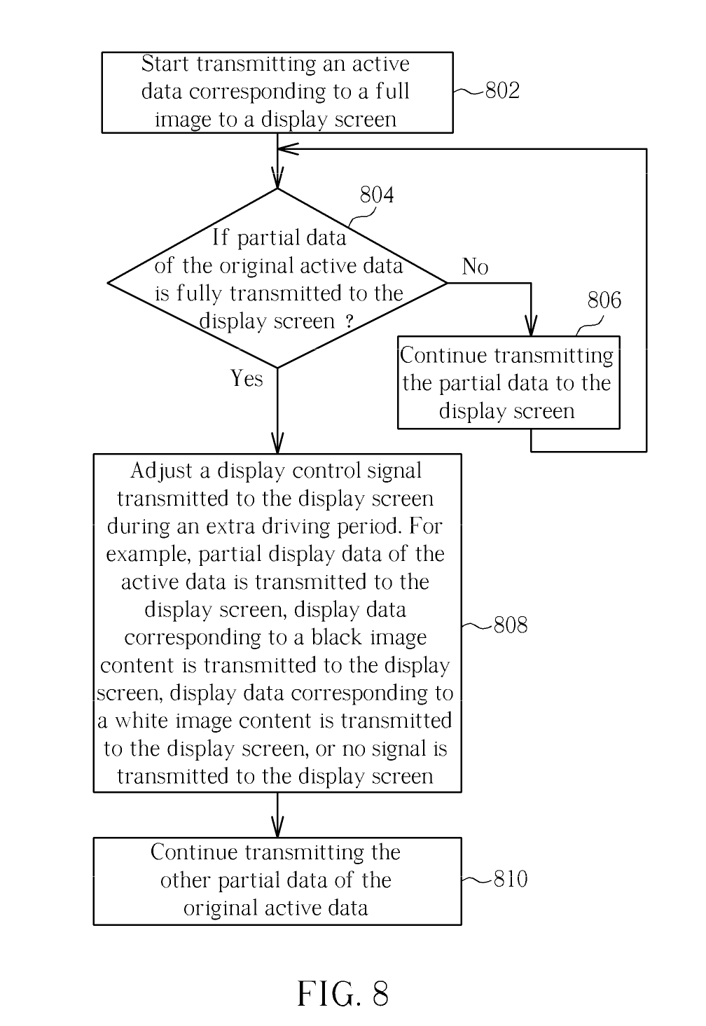

FIG. 8 is a flowchart illustrating the image display method outputting display control signal to the display screen according to a second exemplary embodiment of the present invention. The flowchart may be concluded as below:

Step 802: Start transmitting an active data (e.g., D1/D2) corresponding to a full image (e.g. L1/R1) to a display screen;

Step 804: Determine if partial data (e.g., D1_1/D2_1) of the original active data (e.g., D1/D2) is fully transmitted to the display screen. If yes, go to step 808; otherwise, go to step 806;

Step 806: Continue transmitting the partial data (e.g., D1_1/D2_1) to the display screen, and execute step 804;

Step 808: Adjust a display control signal transmitted to the display screen during an extra driving period (e.g., P1/P2). For example, partial display data of the active data is transmitted to the display screen, display data corresponding to a black image content is transmitted to the display screen, display data corresponding to a white image content is transmitted to the display screen, or no signal is transmitted to the display screen. Besides, a period length of the extra driving period is not equal to a period length of transmitting the active data of the full image to the display screen;

Step 810: Continue transmitting the other partial data (e.g., D1_2/D2_2) of the original active data (e.g., D1/D2).

As those skilled in the art will readily understand the operation of each step shown in FIG. 7 and FIG. 8 after reading above paragraphs, further description is omitted here for brevity.

Please note that the technique of the present invention that adjusts a display control signal transmitted to the display screen during an extra driving period for allowing the transmission of the active data of the full image to be finished in advance is not limited to the application of 3D image display. It may also be utilized in the application of 2D image display. For example, the video apparatus 104 of the image display system 100 may be operated in a 2D image display mode. Therefore, the user may watch the 2D images presented by the video display apparatus 104 without wearing the pair of 3D glasses 102. At this time, since the video display apparatus 104 does not collaborate with the pair of 3D glasses 102 when operated in the 2D image display mode, the pair of 3D glasses 102 in FIG. 2 and FIG. 6 does not need to be switched between the on-state “ON” and the off-state “OFF”. In addition, L1 and R1 simply represent two successive images, and are not categorized into a left-eye image and a right-eye image. As those skilled in the art will readily know the operation of the video display apparatus 104 operated in the 2D image display mode according to the aforementioned description, further description is omitted here for brevity.

According to the exemplary embodiment shown in FIG. 3, when the display screen 122 receives the output of the display control circuit 124 during the extra driving period (e.g., the partial display data D1′/D2′), the display screen 122 will display the corresponding image content. However, this is not meant to be a limitation of the present invention. For example, when the display screen 122 receives the output of the display control circuit 124 (e.g., the partial display data, the display data corresponding to the black image content, or the display data corresponding to the white image content transmitted by the display control circuit 124) or does not receive any output of the display control circuit 124 (e.g., the display control circuit 124 does not transmit any signal to the display screen 122) during the extra driving period, the display screen 122 may directly ignore the display control signal SC (e.g., the aforementioned partial display data D1′/D2′) according to its software/hardware configuration, or perform corresponding signal processing upon the display control signal SC (e.g., the aforementioned partial display data D1′/D2′).

Besides, when the display control circuit 124 adjusts the display control signal SC transmitted to the display screen 122 during the extra driving period for outputting the extra display data (e.g., the partial display data, the display data corresponding to the black image content, or the display data corresponding to the white image content) or not outputting any signal, the display screen 122 should be able to detect a display driving state for directly ignoring the display control signal SC or performing corresponding signal processing upon the display control signal SC. Otherwise, the display screen 122 may execute unpredicted action, thus failing to display images or displaying incorrect image content. For example, in a first exemplary embodiment, the display control circuit 124 further outputs a data enable signal DE to the display screen 122. Therefore, the display screen 122 may directly identify which signal content is active display data according to the data enable signal DE. In a second exemplary embodiment, the display screen 122 may directly detect the display control signal SC to determine whether the display control circuit 124 employs the driving mechanism of the present invention. For example, suppose that the resolution of the image is 1920×1080. When the display screen 122 detects that the display control circuit 124 has continuously transmitted data for 2200 scan lines or detects that the signal transmission bandwidth between the display control circuit 124 and the display screen 122 reaches 400 Mhz, the display screen 122 determines that the display control circuit 124 does employ the driving mechanism of the present invention to finish transmitting the active data in advance. Moreover, the operational characteristics of the display control circuit 124 are known, and the display screen 122 is properly designed to collaborate with the display control circuit 124. Therefore, when the display screen 122 determines that the display control circuit 124 employs the driving mechanism of the present invention, the display screen 122 may refer to the known information to correctly know when the display control circuit 124 is operated during the extra driving period. So, the display screen 122 may ignore the display control signal SC or perform corresponding signal processing upon the display control signal SC at the correct time point. In a third exemplary embodiment where the operational characteristics of the display control circuit 124 are known, the display screen 122 is properly designed to collaborate with the display control circuit 124, and the display control circuit 124 employs the driving mechanism of the present invention fixedly, the display screen 122 may be designed beforehand to correctly know when the display control circuit 124 is operated during the extra driving period, and ignore the display control signal SC (e.g., the aforementioned partial display data D1′/D2′) or perform corresponding signal processing upon the display control signal SC (e.g., the aforementioned partial display data D1′/D2′).

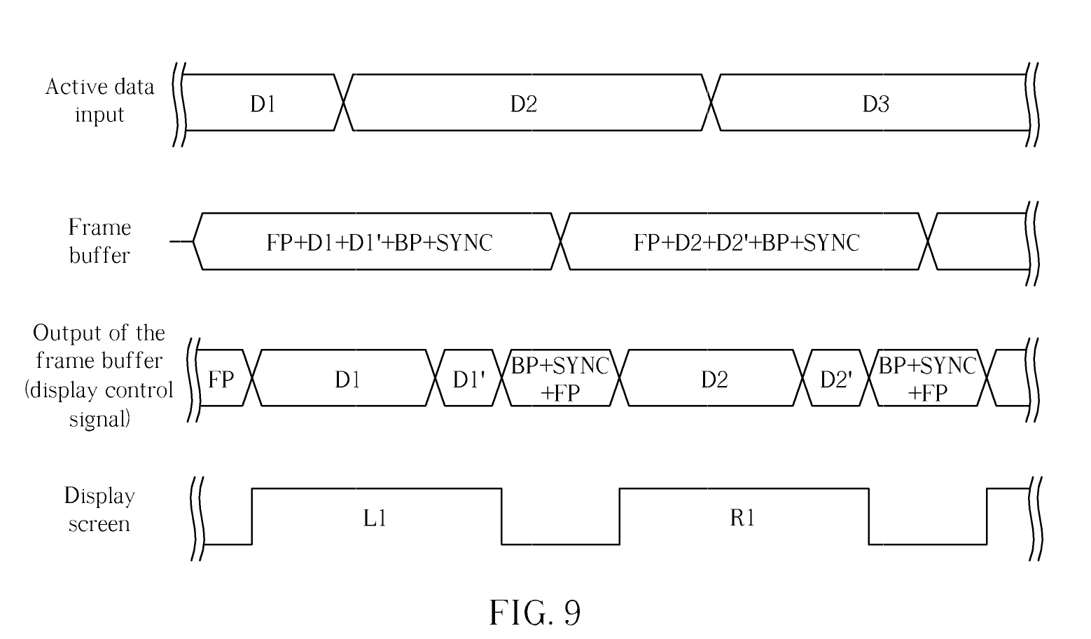

In practice, the image driving mechanism disclosed by present invention is required to collaborate with a buffer (e.g., a frame buffer). Please refer to FIG. 9, which is a timing diagram of an active data, a frame buffer and a display screen, wherein D1-D3 respectively represent original active data of different images (e.g., D1 corresponds to image L1, and D2 corresponds to the following image R1). In an exemplary embodiment, the frame buffer of the display control circuit may be utilized for buffering the original active data. Besides, the micro-processor of the display control circuit may generate the extra display data (e.g., extra display data derived from one or more scan lines of the original active data, or derived from generating display data of white/black image content), and temporarily store the extra display data into the frame buffer. In other words, when receiving the original active data, the processing unit of the display control circuit processes all the received active data, and the processed data includes not only the original active data and the extra display data, but also the front porch signal data, the back porch signal data and the synchronization signal data. Moreover, the micro-processor of the display control circuit will temporarily store the processed data into the frame buffer, and the frame buffer will output the temporarily stored data to act as the display control signal used for driving the display screen at a proper time point.

Those skilled in the art will readily observe that numerous modifications and alterations of the device and method may be made while retaining the teachings of the invention.

What is claimed is:

1. An image display method, comprising:
transmitting an active data of a full image to a display screen; and
after transmitting the active data to the display screen is finished and before a driving period of an original vertical blanking interval (VBI) corresponding to the active data is started, adjusting a display control signal transmitted to the display screen during an extra driving period, wherein a period length of the extra driving period is not equal to a period length of transmitting the active data of the full image to the display screen.

2. The image display method of claim 1, wherein the step of adjusting the display control signal transmitted to the display screen during the extra driving period comprises:
transmitting a partial display data derived from the active data to the display screen.

3. The image display method of claim 2, further comprising:
switching on a lens, utilized for watching the full image and included in a pair of three-dimensional (3D) glasses, during a period of transmitting the partial display data to the display screen.

4. The image display method of claim 2, further comprising:
sequentially transmitting the active data and the partial display data to the display screen.

5. The image display method of claim 1, wherein the step of adjusting the display control signal transmitted to the display screen during the extra driving period comprises:
transmitting a display data corresponding to a black image content or a white image content to the display screen; or
not transmitting any signal to the display screen during the extra driving period.

6. An image display system, comprising:
a video display apparatus, comprising:
a display screen; and
a display control circuit, coupled to the display screen, arranged for transmitting an active data of a full image to the display screen, and after transmitting the active data to the display screen is completed and before a driving period of an original vertical blanking interval (VBI) corresponding to the active data is started, arranged for adjusting a display control signal transmitted to the display screen during an extra driving period, wherein a period length of the extra driving period is not equal to a period length of transmitting the active data of the full image to the display screen.

7. The image display system of claim 6, wherein the display control circuit is further arranged for transmitting a partial display data derived from the active data to the display screen during the extra driving period.

8. The image display system of claim 7, further comprising:
a pair of three-dimensional glasses (3D glasses);
wherein a lens included in the pair of 3D glasses for watching the full image is switched on during a period in which the display control circuit transmits the partial display data to the display screen.

9. The image display system of claim 7, wherein the display control circuit is further arranged for receiving the active data from a signal source, generating the partial display data according to the received active data, and sequentially transmitting the received active data and the generated partial display data to the display screen.

10. The image display system of claim 7, wherein the display control circuit is further arranged for receiving the active data and the partial display data from a signal source, and sequentially transmitting the received active data and the partial display data to the display screen.

11. The image display system of claim 6, wherein the display control circuit is further arranged for transmitting a display data corresponding to a black image content or a white image content to the display screen during the extra driving period; or the display control circuit is further arranged for not transmitting any signal to the display screen during the extra driving period.

12. An image display method, comprising:
transmitting an active data of a full image to a display screen; and
after transmitting the active data to the display screen is started and before transmitting the active data to the display screen is finished, adjusting a display control signal transmitted to the display screen during at least an extra driving period.

13. The image display method of claim 12, wherein the step of adjusting the display control signal transmitted to the display screen during the extra driving period comprises:
transmitting a partial display data derived from the active data to the display screen.

14. The image display method of claim 13, further comprising:
sequentially transmitting the active data and the partial display data to the display screen.

15. The image display method of claim 12, wherein the step of adjusting the display control signal transmitted to the display screen during the extra driving period comprises:
transmitting a display data corresponding to a black image content or a white image content to the display screen; or
not transmitting any signal to the display screen during the extra driving period.

16. The image display method of claim 12, further comprising:
switching on a lens, utilized for watching the full image and included in a pair of three-dimensional (3D) glasses, after transmitting the active data to the display screen is finished.

17. An image display system, comprising:
a video display apparatus, comprising:
a display screen; and
a display control circuit, coupled to the display screen, arranged for transmitting an active data of a full image to the display screen, and after transmitting the active data to the display screen is started and before transmitting the active data to the display screen is finished, arranged for adjusting a display control signal transmitted to the display screen during an extra driving period.

18. The image display system of claim 17, wherein the display control circuit is further arranged for transmitting a partial display data derived from the active data to the display screen during the extra driving period.

19. The image display system of claim 18, wherein the display control circuit is further arranged for receiving the active data from a signal source, generating the partial display data according to the received active data, and sequentially transmitting the received active data and the generated partial display data to the display screen.

20. The image display system of claim 18, wherein the display control circuit is further arranged for receiving the active data and the partial display data from a signal source, and sequentially transmitting the received active data and the partial display data to the display screen.

21. The image display system of claim 17, wherein the display control circuit is further arranged for transmitting a display data corresponding to a black image content or a white image content to the display screen during the extra driving period; or the display control circuit is further arranged for not transmitting any signal to the display screen during the extra driving period.

22. The image display system of claim 17, further comprising:
a pair of three-dimensional (3D) glasses;
wherein a lens included in the pair of 3D glasses for watching the full image is switched on after the display control circuit finishes transmitting the active data to the display screen.
